(19) United States
(12) Patent Application Publication
(10) Pub. No.: US 2024/0398667 A1
(43) Pub. Date: Dec. 5, 2024

(54) AUTOMATED MEDICINE SORTING AND MEDICINE DISPENSING SYSTEM

(71) Applicant: Kin Technology Limited, Kowloon (HK)

(72) Inventors: Hin Oswin YEUNG, Hong Kong (HK); Tsz Hang WONG, Hong Kong (HK)

(21) Appl. No.: 18/801,594

(22) Filed: Aug. 12, 2024

Related U.S. Application Data
(63) Continuation of application No. 17/644,275, filed on Dec. 14, 2021.

(51) Int. Cl. A61J 7/00; A61J 1/03

(52) U.S. Cl. CPC A61J 7/0084; A61J 1/03; A61J 2200/70; A61J 2200/72

(57) ABSTRACT

An automated medicine sorting and medicine dispensing system comprising: a medicine storage mechanism (110) for storing a plurality of types of medicine; a medicine picking up mechanism (120) for picking up medicines from said medicine storage mechanism (110); and a rotating base (130) comprising a housing chamber (134), a rotating pad that is set within said housing chamber (134) and an electrical motor (131) that drives said rotating pad to rotate, wherein said housing chamber (134) is in communication with a medicine discharging passage. The automated medicine sorting and medicine dispensing system not only can realize automated medicine sorting and medicine dispensing, but also has the advantages of small volume, full functions and better user experience. Moreover, a portable medicine box is also provided, which is easy for a user to carry.

### CROSS-REFERENCE TO RELATED APPLICATIONS

This application is a continuation of the U.S. application Ser. No. 17/644,275 filed on 14 Dec. 2021, entitled “AUTOMATED MEDICINE SORTING AND MEDICINE DISPENSING SYSTEM”, which is a continuation of International Patent Application No. PCT/CN2020/097308, filed on Jun. 22, 2020, which claims the benefit and priority of Hong Kong Patent Application Number 19127016.4, filed on Jul. 18, 2019, the disclosures of which are incorporated herein by reference in their entireties.

### TECHNICAL FIELD OF THE INVENTION

The present invention relates to a medicine management system, and especially relates to an automated medicine sorting and medicine dispensing system.

### BACKGROUND OF THE TECHNOLOGY

In daily life, automated medicine sorting and medicine dispensing systems are often used to help people, such as the elderly or people with chronic diseases, take their medicines on time. Existing automated medicine sorting and medicine dispensing system generally include a medicine storage box and a picking up mechanism for pick up medicines from the medicine storage box.

However, there are still many areas for improvement in the existing medicine storage boxes, such as insufficient portability, large size, complex structure, and so on.

### SUMMARY OF THE INVENTION

The technical problem to be solved by the embodiments of the present invention is to provide a novel automated medicine sorting and medicine dispensing system in view of the above-mentioned at least one defect of the existing automated medicine sorting and medicine dispensing system.

In order to solve the above mentioned technical problems, the embodiment of the present invention provides an automated medicine sorting and medicine dispensing system characterized by comprising: a medicine storage mechanism for storing a plurality of types of medicine; a medicine picking up mechanism for picking up medicine from said medicine storage mechanism; and a rotating base comprising a housing chamber, a rotating pad that is set within said housing chamber and an electrical motor that drives said rotating pad to rotate, wherein said housing chamber is in communication with a medicine discharging passage.

Preferably, said automated medicine sorting and medicine dispensing system further comprises: a portable medicine box for receiving medicines sorted and dispensed, said portable medicine box couples with said rotating pad, said portable medicine box comprises a plurality of medicine storage slots, said plurality of medicine storage slots are able to rotate around the axis of said portable medicine box.

Preferably, said automated medicine sorting and medicine dispensing system further comprises a cup for receiving medicines sorted and dispensed, said portable medicine box couples with said rotating pad.

Preferably, the rotating pad comprises a medicine box coupling portion and a cup coupling portion, said medicine box coupling portion couples with said portable medicine box, said cup coupling portion couples with said cup, said medicine box coupling portion at least partly overlaps with said cup coupling portion.

Preferably, said medicine picking up mechanism comprises a first foldable machine arm, a second foldable machine arm, a suction nozzle and a driving mechanism, in idle status, said first foldable machine arm and second foldable machine arm are folded in the horizontal direction, in working status, said first foldable machine arm and said second foldable machine arm cooperate mutually to move in the horizontal direction and the vertical direction under the action of the driving mechanism, said suction nozzle is connect at one end of said second foldable machine arm, and sucks medicines by negative pressure.

Preferably, said medicine picking up mechanism further comprise a pump and a suction tube, said suction tube connects said pump and said suction nozzle, said pump is used for delivering the generated vacuum to said suction nozzle through said suction tube.

Preferably, said medicine storage mechanism comprises a rotating table and a plurality of medicine storage containers that engage within said rotating table, a protruding hollow passage is set in the middle of said rotating table, said rotating table is able to rotate around said hollow passage under the driving of an electrical motor, said hollow passage is in communication with the medicine discharging opening of said automated medicine sorting and medicine dispensing system which is aligned with the overlapping portion of said medicine box coupling portion and said cup coupling portion.

Preferably, said medicine picking up mechanism further comprises a cover plate, a horizontal slide rail provided on said cover plate, and a first opening and a second opening opened on said cover plate, said cover plate rotatably couples with said rotating table, said first opening is in communication with said hollow passage, and said second opening is in communication with said medicine storage container.

Preferably, said first foldable machine arm comprises a first upper arm and a first lower arm, said second foldable machine arm comprises a second upper arm and a second lower arm, one end of said first upper arm is slidingly connected with said horizontal slide rail, said medicine picking up mechanism further comprises first, second, and third hinges, one end of said first upper arm and one end of said second upper arm are connected with said first hinge, the other end of said first upper arm and the other end of said second upper arm, as well as one end of said first lower arm and one end of said second lower arm are connected with said second hinge, the other end of said first lower arm and the other end of said second lower arm are connected with said third hinge, said third hinge is connected with said suction nozzle.

Preferably, said automated medicine sorting and medicine dispensing system further comprises a medicine loading door which opens under the control of a electromagnetic valve.

Preferably, said medicine storage container has a curved bottom surface on which at least one slope is provided.

Preferably, said automated medicine sorting and medicine dispensing system further comprises a sensing system for sensing location, temperature, and humidity information.

Preferably, said automated medicine sorting and medicine dispensing system further comprises a control system for controlling each controllable element.

Implementation of that embodiment of the present invention has the following beneficial effects: the automated medicine sorting and medicine dispensing system provided by the present invention not only can realize automated medicine sorting and medicine dispensing, but also has the advantages of small volume, full functions and better user experience. Moreover, a portable medicine box is also provided, which is easy for an user to carry.

### DESCRIPTION OF THE DRAWINGS

In order to illustrate the embodiments of the present invention or the technical solutions in the prior art more clearly, a brief description of the drawings to be used in the description of the embodiment or the prior art will be given below. It is obvious that, the drawings in the following description are merely some embodiments of the present invention, and other drawings may be obtained from these drawings without any creative work by those of ordinary skill in the art.

FIG. 1 is a structural exploded view of the automated medicine sorting and medicine dispensing system provided by the present invention.

FIG. 2 is a structural disassembled schematic view of the portable medicine box provided by the present invention.

FIG. 3 is a structural schematic view of the portable medicine box provided by the present invention from another angle.

FIG. 4 is a box body structural schematic view of the portable medicine box provided by the present invention.

FIG. 5 is a structural schematic view of the medicine picking up mechanism provided by the present invention.

FIG. 6 is a structural schematic view of the medicine picking up mechanism provided by the present invention from another angle.

FIG. 7 is a structural schematic view of the medicine picking up mechanism provided by the present invention from yet another angle.

FIG. 8 is a structural schematic view of the medicine storage mechanism provided by the present invention.

FIG. 9 is a structural schematic view of the medicine storage mechanism provided by the present invention from another angle.

FIG. 10 is a sectional view of the medicine storage container provided by the present invention.

FIG. 11 is a structural schematic view of the medicine storage container provided by the present invention.

FIG. 12 is a structural schematic view of the rotating base provided by the present invention.

FIG. 13 is a structural schematic view of the rotating base provided by the present invention from another angle.

FIG. 14 is a structural schematic view of the rotating base provided by the present invention from yet another angle.

FIG. 15 is a structural schematic view of the rotating base provided by the present invention, in which a cup is located in the rotating base.

FIG. 16 is a structural schematic view of the rotating base provided by the present invention, in which the portable medicine box is located in the rotating base.

FIG. 17 is a structural block view of the automated medicine sorting and medicine dispensing system provided by the present invention.

FIG. 18 is a assembled structural schematic view of the automated medicine sorting and medicine dispensing system provided by the present invention.

FIG. 19 is a structural schematic view of the medicine loading door provided by the present invention.

FIG. 20 is a schematic view of the medicine loading flow provided by the present invention.

### DESCRIPTION OF EXEMPLARY EMBODIMENTS

The technical solutions in the embodiments of the present invention will be explained clearly and fully in the following text in conjunction with the drawing in the embodiments of the present invention. It's obvious that the described embodiments are merely a part of the embodiments and not all the embodiments of the present invention. Based on the embodiments of the present invention, all the other embodiments obtained by a person of ordinary skill in the art without creative work fall into the scope of protection of the present invention.

In the specification and the appended figures, like numbers represent like parts. The parts in the present invention may be singular and may also be plural, the specific number is not limited, unless specifically indicated.

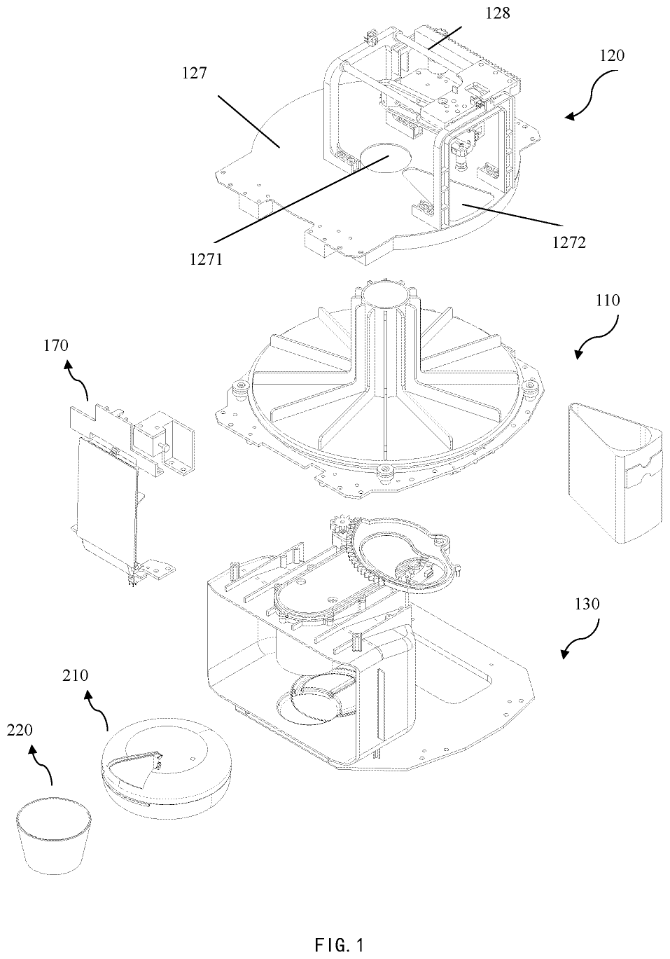

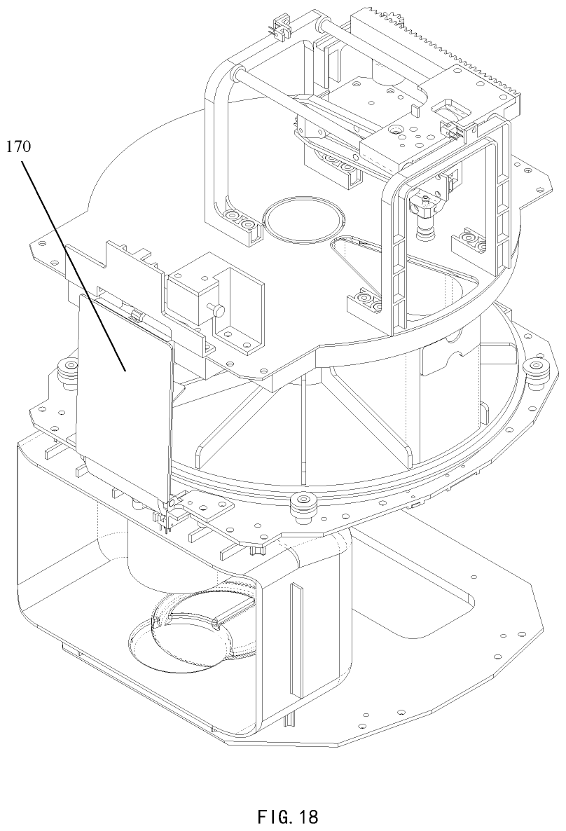

As shown in FIGS. 1-20, the automated medicine sorting and medicine dispensing system comprises: a medicine storage mechanism 110 which is for storing a plurality of types of medicine; a medicine picking up mechanism 120 for picking up medicines from the medicine storage mechanism 110; and a rotating base 130 comprising a housing chamber 134, rotating pad (i.e. medicine box coupling portion 132 and cup coupling portion 133) that is set within the housing chamber 134 and an electrical motor 131 that drives the rotating pad to rotate. The housing chamber 134 is in communication with a medicine discharging passage.

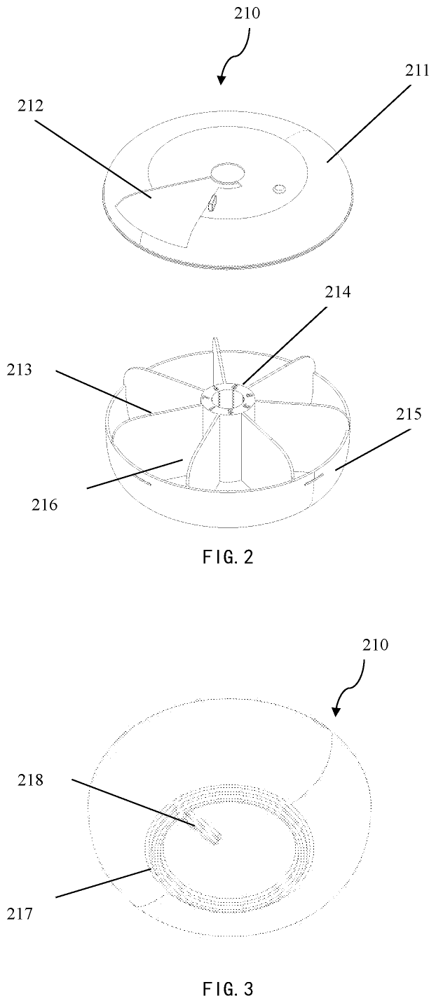

As shown in FIG. 1 and FIGS. 15 and 16, the automated medicine sorting and medicine dispensing system further comprises a portable medicine box 210 and a cup 220, which are used for receiving medicines sorted and dispensed. The portable medicine box 210 and the cup 220 may located within the housing chamber 134, coupling with the rotating pad. As shown in FIGS. 2-4 and 16, the portable medicine box 210 couples with the medicine box coupling portion 132. The portable medicine box 210 comprises a box lid 211, a box body that forms a medicine storage chamber in cooperation with the box lid, and a separating plate 213 located within the medicine storage chamber. The separating plate 213 separates the medicine storage chamber into a plurality of medicine containing slots 216. As the medicine box coupling portion 132 rotates, the plurality of medicine containing slots may rotate around the axis 212 of the portable medicine box 210.

In the portable medicine box 200, the number of the medicine containing slots 216 may be 2-10, and may also be other suitable number which is not limited herein.

A rotating door 212 is provided on the box lid 211. The rotating door 212 corresponds to the medicine containing slots 216. The rotating door 212 may rotate around the axis 214 of the portable medicine box 210, and thus open or close the medicine containing slots, making it easier to pick and place medicines.

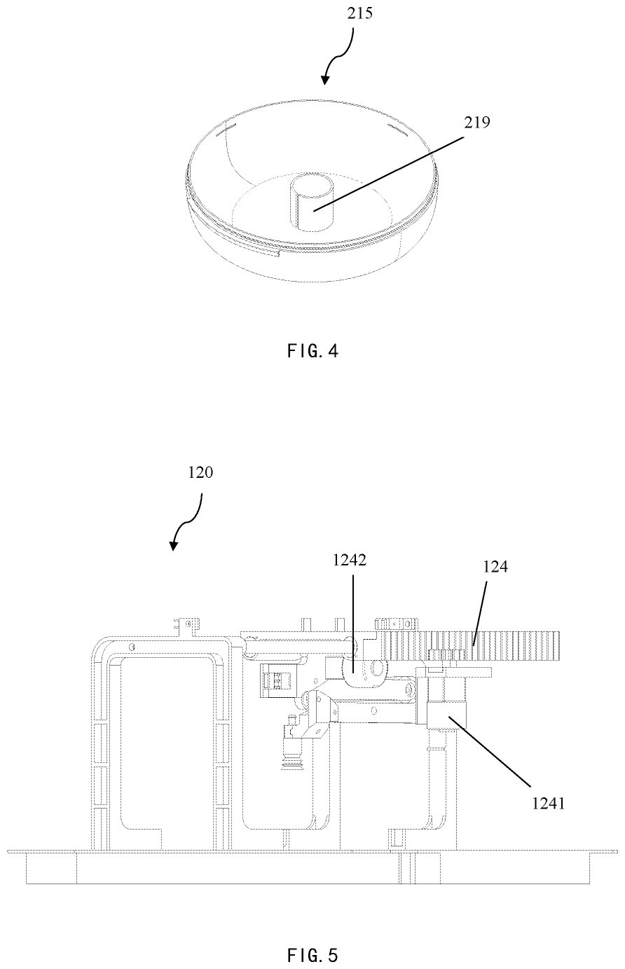

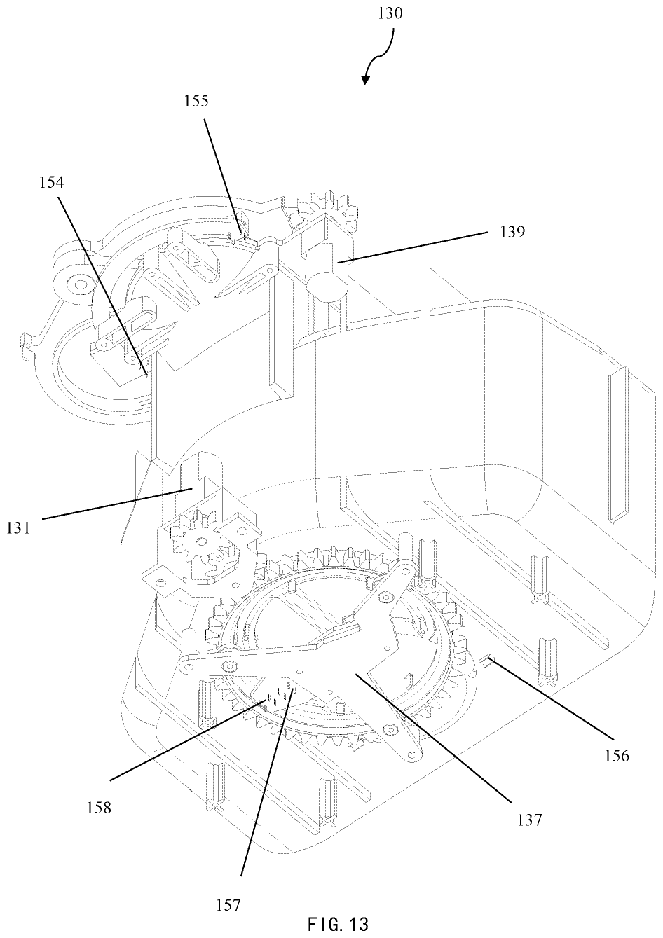

As shown in FIG. 4, a magnetic component 219 is provided at the bottom of the box body 211. The magnetic component 219 interacts with a magnetic switch 137 set at the bottom of the rotating base 130, for detecting whether the portable medicine box 210 is located on the medicine box coupling portion 132 (FIG. 13).

As shown in FIG. 2, a plurality of medicine containing slots 216 may be evenly set around the axis 214, and thus make the whole portable medicine box 210 take on shapes similar to cylinder. Of course, shapes of the plurality of medicine containing slots 216 may also vary from each other. The overall shape of the portable medicine box 210 may also be other shapes, e.g. cuboid, star shape, heart shape, sphere, or other irregular shape, and is not limited herein.

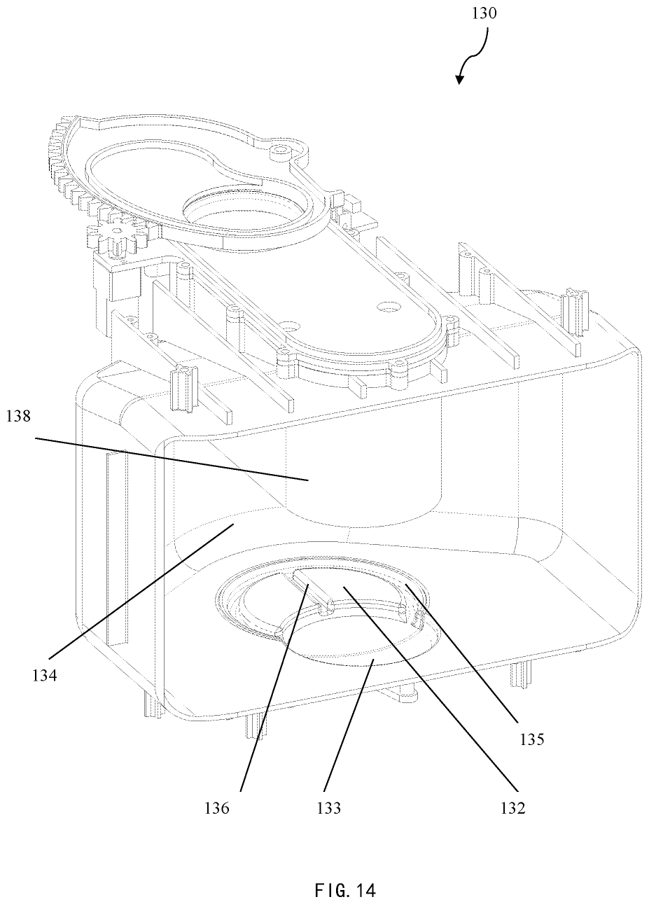

As shown in FIG. 3, the bottom of the portable medicine box 210 is provided with a round projection 217 and a linear projection 218. Accordingly, as shown in FIG. 14, an annular groove 135 and a linear groove 136 are provided on the medicine box coupling portion 132 correspondingly, to couple with the round projection 217 and the linear projection 218, respectively. After the round projection 217 is fitted with the annular groove 135, the portable medicine box 210 may be fixed on the medicine box coupling portion 132, rotating along with the rotation of the medicine box coupling portion 132. The fitting of the linear projection 218 and the linear groove 136 may, on one hand, fix the portable medicine box 210 on the medicine box coupling portion 132, and on the other hand, limit the initial position of the portable medicine box 210 on the medicine box coupling portion 132, to ensure that the medicine containing slots 216 in the portable medicine box 210 are in correct and fixed order. Of course, the coupling manner of the portable medicine box 200 with the medicine box coupling portion 132 may be other manner, e.g. snap-fitting, which is not limited herein insofar as the tight fit between the portable medicine box 200 and the medicine box coupling portion 132 can be guaranteed.

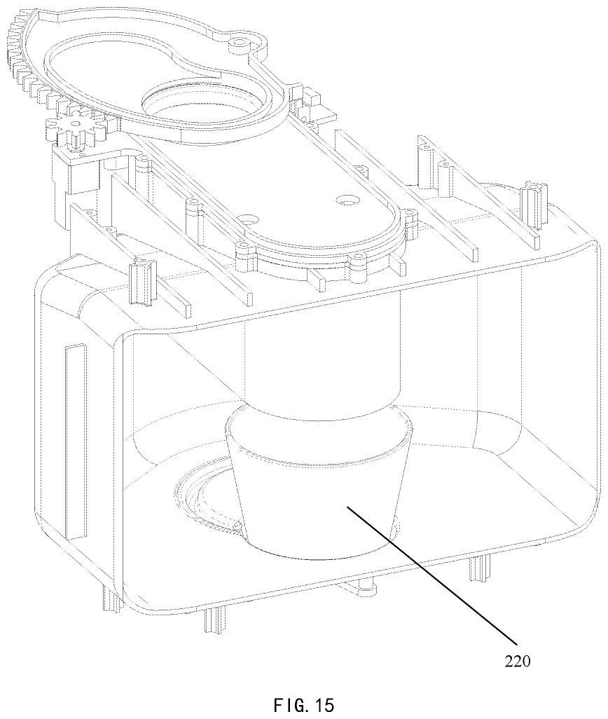

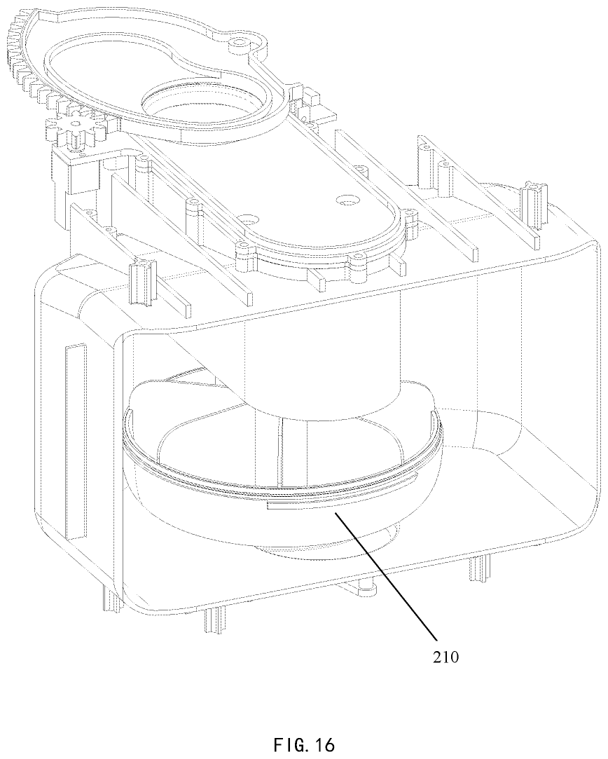

As shown in FIG. 14, the rotating pad comprises the medicine box coupling portion 132 and the cup coupling portion 133. The medicine box coupling portion 132 couples with the portable medicine box 210. The cup coupling portion 133 couples with the cup 220. The medicine box coupling portion 132 at least partly overlaps with the cup coupling portion 133. This kind of overlapping structure may ensure that there is only one kind of container (the portable medicine box 210 or the cup 220) present on the rotating pad, rather than more than one kind of containers present on the rotating pad, as shown in FIGS. 15 and 16.

As shown in FIGS. 5-7, the medicine picking up mechanism 120 comprises: a first foldable machine arm 121, a second foldable machine arm 122, a suction nozzle 123 and a driving mechanism 124. The driving mechanism 124 comprises a first electrical motor 1241 that drives the first and second foldable machine arms 121 and 122 to move in the horizontal direction and a second electrical motor 1242 that drives the first and second foldable machine arms 121 and 122 to move in the vertical direction. So-called vertical direction is the depth direction of the medicine storage mechanism 110.

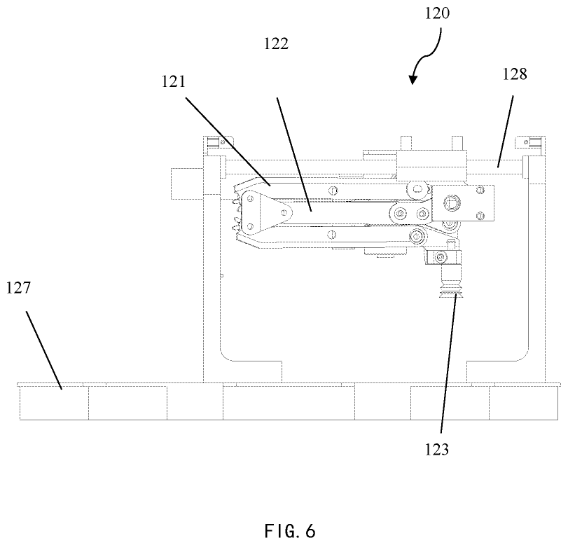

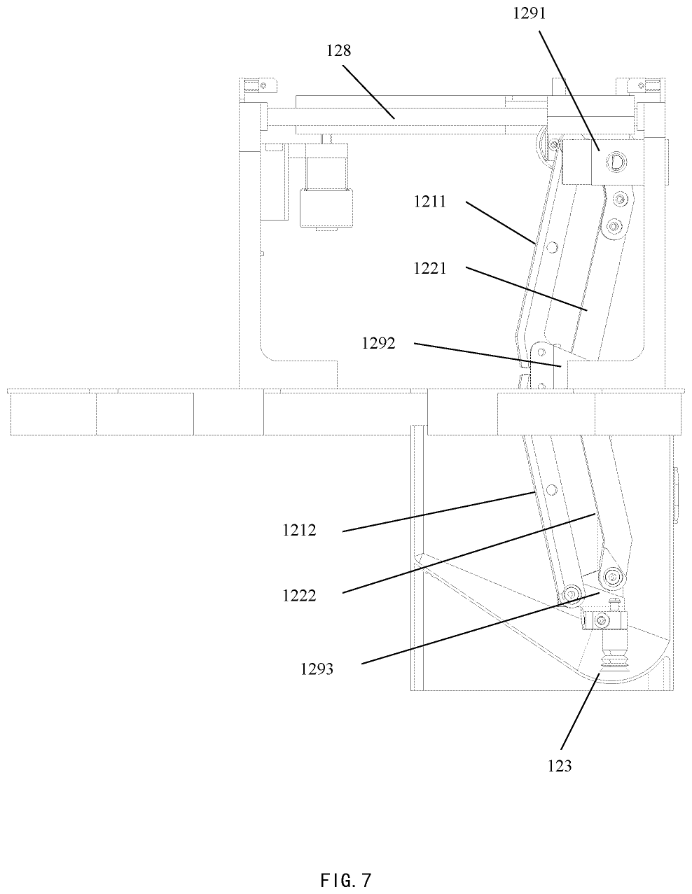

As shown in FIG. 6, in idle status, the first foldable machine arm 121 and the second foldable machine arm 122 are folded in the horizontal direction. As shown in FIG. 7, in working status, the first foldable machine arm 121 and the second foldable machine arm 122 cooperate mutually to move in the horizontal direction and the vertical direction under the action of the driving mechanism 124. The suction nozzle 123 is connect at one end of the second foldable machine arm 122, and sucks medicines by negative pressure.

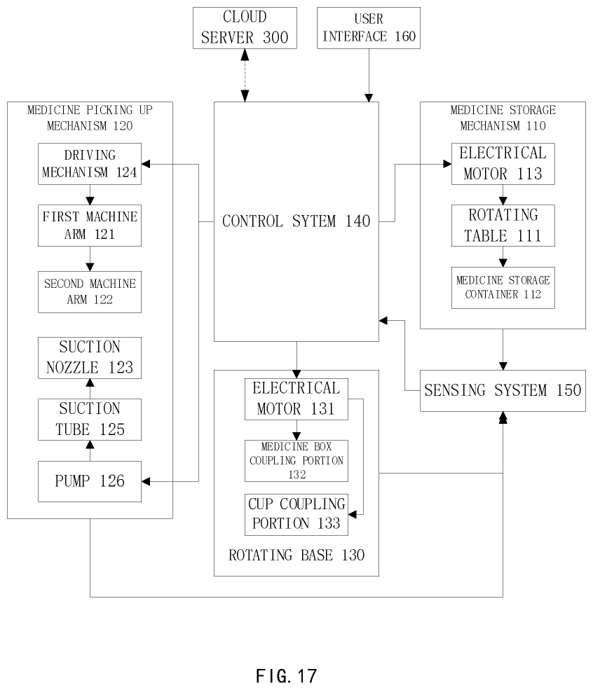

As shown in FIG. 17, the medicine picking up mechanism 120 further comprises a pump 126 and a suction tube 125. The suction tube 125 connects the pump 126 and the suction nozzle 123. The suction tube 125 is further connected to a pressure sensor. The pressure sensor is used for detecting whether the suction nozzle 123 is sucking any object. When the nozzle 123 sucks an object, the pressure of the suction tube 125 changes, then the pressure sensor may determine whether the object is sucked by the change in the pressure. The pump 126 is used for delivering the generated vacuum to the suction nozzle 123 through the suction tube 126.

As shown in FIGS. 1, 8-11, the medicine storage mechanism 110 comprises a rotating table 111 and a plurality of medicine storage containers 112 that engage within the rotating table 111. A protruding hollow passage 114 is set in the middle of the rotating table 111. The rotating table 111 is able rotate around the hollow passage 114 under the driving of the electrical motor 113. The hollow passage 114 is in communication with the medicine discharging opening 138 (FIG. 14) of the automated medicine sorting and medicine dispensing system which is aligned with the overlapping portion of the medicine box coupling portion 132 and the cup coupling portion 133. Therefore, regardless of whether the portable medicine box 210 or the cup 220 is placed on the rotating pad, medicines discharged from the medicine discharging opening 138 can drop exactly into the portable medicine box 210 or the cup 220.

In a embodiment of the present invention, the number of medicine storage containers 112 is 12. The number of medicine storage containers may be designed according to the size and the actual requirements of the automated medicine sorting and medicine dispensing system, and is not limited herein. In the present invention, each medicine storage container 112 has its own number, and the number is printed on the rotating table 111 so that it is easy for users to identify.

Furthermore, as shown in FIG. 1, the medicine picking up mechanism 120 further comprises: a cover plate 127, a horizontal slide rail 128 provided on the cover plate, and a first opening 1271 and a second opening 1272 opened on the cover plate 127. The cover plate 127 rotatably couples with the rotating table 111. The first opening 1271 is in communication with the hollow passage 114, and the second opening 1272 is in communication with the medicine storage container 112.

In the present invention, the first opening 1271, the hollow passage 114, and the medicine discharging opening 138 constitute the medicine discharging passage. As shown in FIG. 7, in operation, the first foldable machine arm 121 and the second foldable machine arm 122 protrude into the medicine storage container 112 through the second opening 1272, and exit from the second opening 1272 after sucks medicines by negative pressure, then protrude into the first opening 1271, lower the medicines. The medicines are sorted and dispensed from the medicine discharging passage, and enter into the portable medicine box 210 or the cup 220 located with the housing chamber 134.

Furthermore, as shown in FIG. 7, the first foldable machine arm 121 comprises a first upper arm 1211 and a first lower arm 1212. The second foldable machine arm 122 comprises a second upper arm 1221 and a second lower arm 1222. One end of the first upper arm 1211 is slidingly connected with the horizontal slide rail 128. The medicine picking up mechanism 120 further comprises first, second, and third hinges 1291, 1292, 1293. One end of the first upper arm 1211 and one end of the second upper arm 1221 are connected with the first hinge 1291, the other end of the first upper arm 1211 and the other end of the second upper arm 1221, as well as one end of the first lower arm 1212 and one end of the second lower arm 1222 are connected with the second hinge 1292, the other end of the first lower arm 1212 and the other end of the second lower arm 1222 are connected with the third hinge 1293, the third hinge 1293 is connected with the suction nozzle 123.

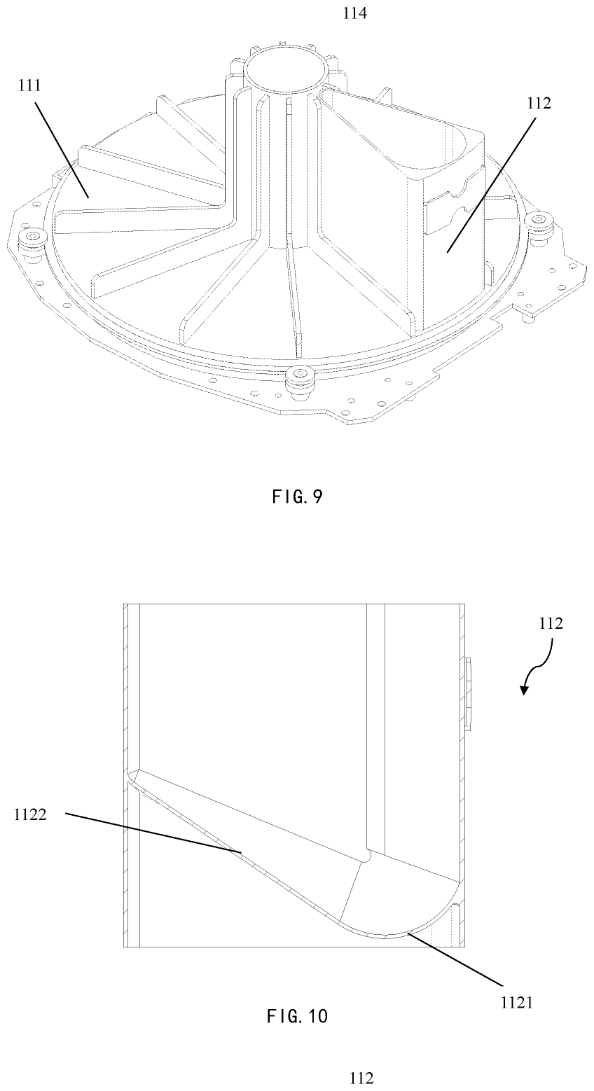

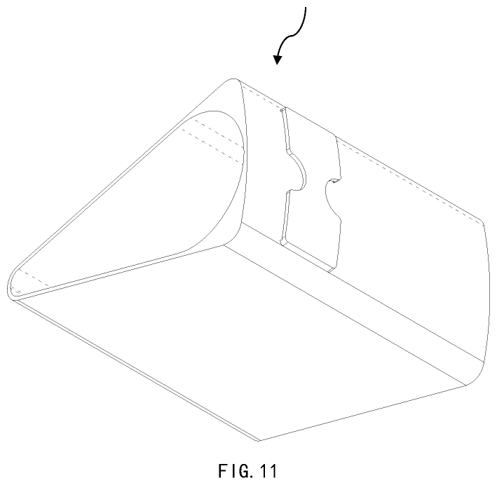

As shown in FIGS. 10 and 11, the medicine storage container 112 has a curved bottom surface 1121 on which at least one slope 1122 is provided. Through this type of unique design, medicines gather within a fixed range of area under the force of gravity, so that they are easy for the suction nozzle 123 to suck.

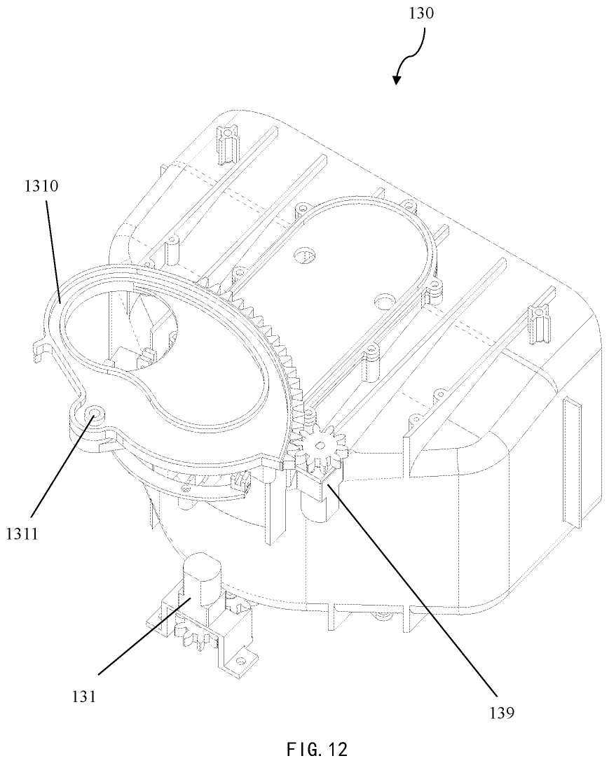

As shown in FIG. 12, the rotating base 130 further comprises a valve 1310. In the medicine sorting and dispensing state, the valve 1310 is opened, so that it is connected with the medicine discharging passage. In the standby state, the valve 1310 is closed to prevent insects from entering the sorting and medicine dispensing system and controlling its internal environment. Under the driving of the electrical motor 139, the valve 1310 may rotate around a pivot 1311, and thus to open or close.

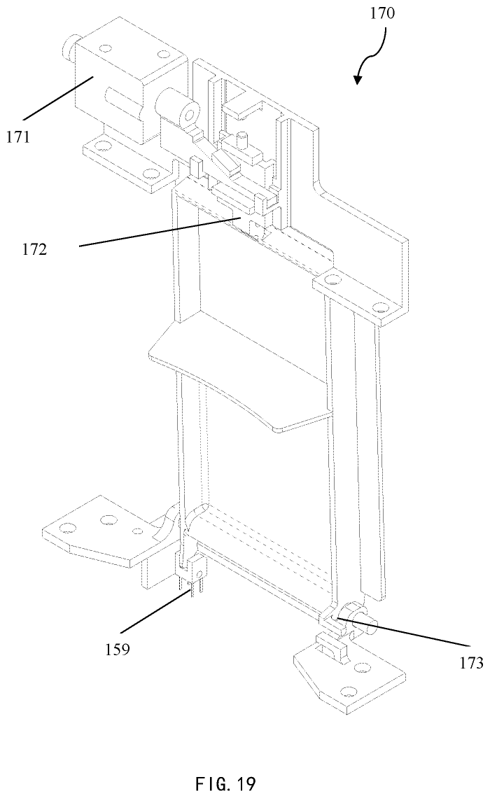

As shown in FIGS. 1 and 18-19, the automated medicine sorting and medicine dispensing system further comprises a medicine loading door 170 which opens under the driving of a electromagnetic valve 171. When the medicine loading door 170 is opened, a user can load medicines into the medicine storage container 112, and when the loading is completed, the medicine loading door 170 can be closed. As shown in FIG. 19, the user can activate the electromagnetic valve 171, thereby releasing the locking mechanism 172 that locks the medicine loading door 170. An infrared sensor 159 for detecting the opening or closing of the medicine loading door is provided at one side below the medicine loading door 170. A movable joint 173 is provided at the other side below the medicine loading door 170 for assisting the medicine loading door 170 to open outward.

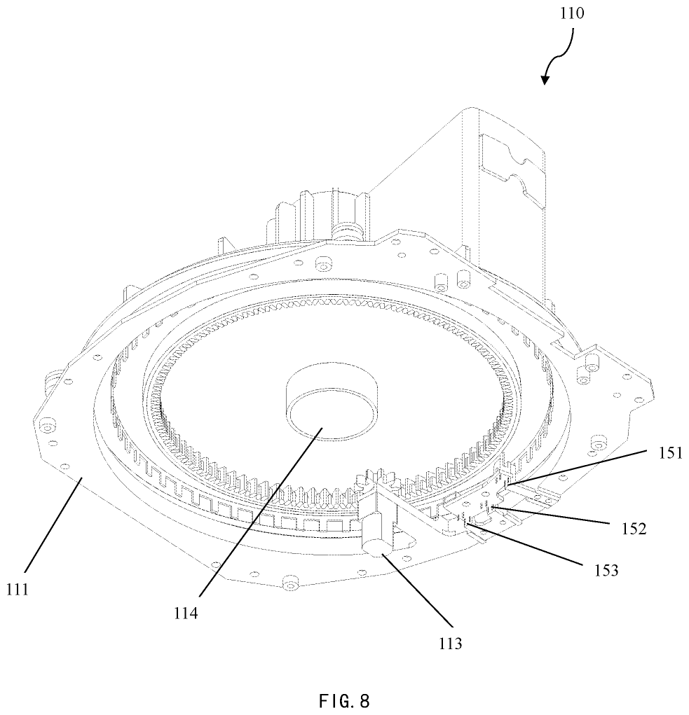

As shown in FIG. 17, the automated medicine sorting and medicine dispensing system further comprises an sensing system 150. As shown in FIG. 8, the sensing system 150 may include an origin infrared sensor 151 provided on the lower surface of the rotating table 111, a right-turn infrared sensor 152 provided on the lower surface of the rotating table 111, and a left-turn sensor 153 provided on the lower surface of the rotating table 111. The medicine storage container 112 is provided on the upper surface of the rotating table 111. The left-turn and right-turn infrared sensors 152 and 153 are also used for detecting the number of rotating steps, thus to enable obtaining the specific position of the rotating table 111. In this case, it is not necessary to rotate the rotating table 111 to the initial (home) position every time the power is turned on, which saves a lot of machine operation time, for example, it is possible to save time for the picking up mechanism 120 to pick up medicines from different medicine storage containers 112.

As shown in FIG. 13, the sensing system 150 further comprises a valve opening infrared sensor 154 for sensing the opening of the valve 1310 and a valve closing infrared sensor 155 for sensing the closing of the valve 1310.

As shown in FIG. 13, the sensing system 150 further comprises a cup infrared sensor (156 is a signal receiver in the infrared sensor, while the signal transmitter is on the other side) for sensing whether a cup is placed in the cup coupling portion 133. The sensing system 150 further comprises a medicine box origin infrared sensor 157 and a medicine box position infrared sensor 158 for sensing the specific position of the medicine containing slot 216 in the portable medicine box 210.

As shown in FIG. 19, and as described above, the sensing system 150 further comprises an infrared sensor 159, for sensing the opening or closing of the medicine loading door 170.

As shown in FIG. 13, a magnetic switch 137 is further provided on the rotating base 137. The magnetic component 219 interacts with the magnetic switch 137 set at the bottom of the rotating base 130 for detecting whether the portable medicine box 210 is located on the medicine box coupling portion 132. When it is detected that the portable medicine box 210 is loaded on the medicine box coupling portion 132, the electrical motor 131 is started, thereby rotating the portable medicine box 210.

In some embodiments provided by the present invention, the sensing system 150 further comprises a temperature sensor, a humidity sensor, for sensing temperature and humidity information.

As shown in FIG. 17, the automated medicine sorting and medicine dispensing system further comprises a control system 140 for controlling each controllable element, such as the driving mechanism 124, the pump 126, the electrical motors 113, 131, 139, etc. The control system 140 is also connected to the sensing system 150 for receiving various sensing information provided by the sensing systems 150, such as location, temperature, and humidity information.

As shown in FIG. 17, the automated medicine sorting and medicine dispensing system further comprises an user interface 160. The user interface 160 may be used by a user for offline management. In the control system 140, a standby state is set. If the user interface 160 does not receive any activation signal from the user, the entire automated medicine sorting and medicine dispensing system will be in the standby state, the power may be minimized.

As shown in FIG. 17, the automated medicine sorting and medicine dispensing system may further be connected to a cloud server 300. The cloud server 300 may store private information of users, such as a prescription. When a user's portable medicine box 210 is placed on the rotating pad, the user may request the automated medicine sorting and medicine dispensing system to automatically retrieve prescriptions from the cloud servers 300, and sort and dispense medicines according to the prescription.

Through the user interface 160 and the control system 140, a user can perform various operations such as medicine sorting and dispensing, medicine management, time management, medicine loading, and parameter setting. In the following, taking medicine loading as an example, the operating principle thereof is described.

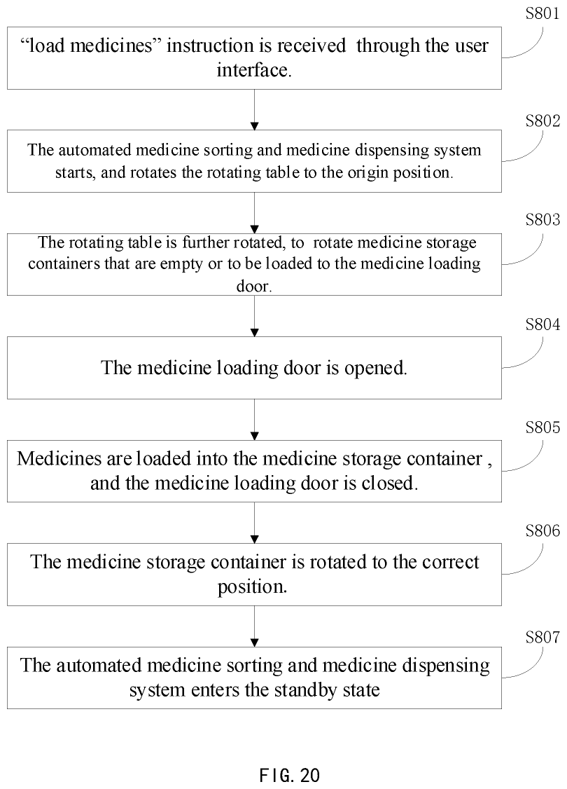

As shown in FIG. 20, in step S801, user may input a “load medicines” instruction through the user interface 160. After receiving the “load medicines” instruction, in step S802, the automated medicine sorting and medicine dispensing system ends the standby state, starts, and rotates the rotating table 111 to the origin position.

In cooperation with the sensing system 150, in step S803, the control system 140 further controls the electrical motor, to drive the rotating table to rotate, thereby rotating medicine storage containers 112 that are empty or to be loaded to the medicine loading door 170.

In step S804, the control system 140 controls the electrical motor to rotate, to open the medicine loading door 170. After the medicine loading door 170 is opened, in step S805, the user loads medicines into the medicine storage container 112, and closes the medicine loading door 170.

After the medicine loading door 170 is closed, in step S806, the control system 140 detects whether the medicine storage container 112 is rotated to the correct position, and if not, controls the electrical motor to drive the medicine storage container 112 to rotate to the correct position.

Subsequently, in step S807, the automated medicine sorting and medicine dispensing system enters the standby state to lower the power consumption of the system.

The above disclosure is only a preferred embodiment of the present invention, and the scope of the invention cannot be limited by this, and those skilled in the art can understand that all or part of the flow of implementing the above embodiment. And equivalent changes made in accordance with the claims of the present invention still fall within the scope of the invention.

We claim:

1. An automated medicine sorting and medicine dispensing system characterized by comprising:
a medicine storage mechanism for storing a plurality of types of medicine;
a medicine picking up mechanism for picking up medicines from said medicine storage mechanism; and
a rotating base comprising a housing chamber, a rotating pad that is set within said housing chamber and an electrical motor that drives said rotating pad to rotate, wherein said housing chamber is in communication with a medicine discharging passage.

2. The automated medicine sorting and medicine dispensing system according to claim 1, characterized in that the automated medicine sorting and medicine dispensing system further comprises:
a portable medicine box for receiving medicines sorted and dispensed, said portable medicine box couples with said rotating pad, said portable medicine box comprises a plurality of medicine storage slots, said plurality of medicine storage slots are able to rotate around the axis of said portable medicine box.

3. The automated medicine sorting and medicine dispensing system according to claim 2, characterized in that the automated medicine sorting and medicine dispensing system further comprises:
a cup for receiving medicines sorted and dispensed, said portable medicine box couples with said rotating pad.

4. The automated medicine sorting and medicine dispensing system according to claim 3, characterized in that said rotating pad comprises a medicine box coupling portion and a cup coupling portion, said medicine box coupling portion couples with said portable medicine box, said cup coupling portion couples with said cup, said medicine box coupling portion at least partly overlaps with said cup coupling portion.

5. The automated medicine sorting and medicine dispensing system according to claim 4, characterized in that said medicine picking up mechanism comprises a first foldable machine arm, a second foldable machine arm, a suction nozzle and a driving mechanism, in idle status, said first foldable machine arm and second foldable machine arm are folded in the horizontal direction, in working status, said first foldable machine arm and second foldable machine arm cooperate mutually to move in the horizontal direction and the vertical direction under the action of the driving mechanism, said suction nozzle is connect at one end of said second foldable machine arm, and sucks medicines by negative pressure.

6. The automated medicine sorting and medicine dispensing system according to claim 5, characterized in that said medicine picking up mechanism further comprise a pump and a suction tube, said suction tube connects said pump and said suction nozzle, said pump is used for delivering the generated vacuum to said suction nozzle through said suction tube.

7. The automated medicine sorting and medicine dispensing system according to claim 5, characterized in that said medicine storage mechanism comprises a rotating table and a plurality of medicine storage containers that engage within said rotating table, a protruding hollow passage is set in the middle of said rotating table, said rotating table is able to rotate around said hollow passage under the driving of an electrical motor, said hollow passage is in communication with the medicine discharging opening of said automated medicine sorting and medicine dispensing system which is aligned with the overlapping portion of said medicine box coupling portion and said cup coupling portion.

8. The automated medicine sorting and medicine dispensing system according to claim 7, characterized in that said medicine picking up mechanism further comprises a cover plate, a horizontal slide rail provided on said cover plate, and a first opening and a second opening opened on said cover plate, said cover plate rotatably couples with said rotating table, said first opening is in communication with said hollow passage, and said second opening is in communication with said medicine storage container.

9. The automated medicine sorting and medicine dispensing system according to claim 8, characterized in that said first foldable machine arm comprises a first upper arm and a first lower arm, said second foldable machine arm comprises a second upper arm and a second lower arm, one end of said first upper arm is slidingly connected with said horizontal slide rail, said medicine picking up mechanism further comprises first, second, and third hinges, one end of said first upper arm and one end of said second upper arm are connected with said first hinge, the other end of said first upper arm and the other end of said second upper arm, as well as one end of said first lower arm and one end of said second lower arm are connected with said second hinge, the other end of said first lower arm and the other end of said second lower arm are connected with said third hinge, said third hinge is connected with said suction nozzle.

10. The automated medicine sorting and medicine dispensing system according to claim 1, characterized in that said automated medicine sorting and medicine dispensing system further comprises a medicine loading door which opens under the control of an electromagnetic valve.

11. The automated medicine sorting and medicine dispensing system according to claim 7, characterized in that said medicine storage container has a curved bottom surface on which at least one slope is provided.

12. The automated medicine sorting and medicine dispensing system according to claim 1, characterized in that said automated medicine sorting and medicine dispensing system further comprises a sensing system for sensing location, temperature, and humidity information.

13. The automated medicine sorting and medicine dispensing system according to claim 1, characterized in that said automated medicine sorting and medicine dispensing system further comprises a control system for controlling each controllable element.
